(19) United States
(12) Patent Application Publication
(10) Pub. No.: US 2021/0343463 A1
(43) Pub. Date: Nov. 4, 2021

(54) ELECTROMAGNETIC ACTUATOR

(71) Applicant: DENSO CORPORATION, Kariya-city (JP)

(72) Inventor: Hitoshi AMANO, Kariya-city (JP)

(21) Appl. No.: 17/241,462

(22) Filed: Apr. 27, 2021

(30) Foreign Application Priority Data
Apr. 30, 2020 (JP) 2020-080243

(51) Int. Cl. H01F 7/08; H01F 7/16

(52) U.S. Cl. CPC H01F 7/081; H01F 2007/086; H01F 7/16

(57) ABSTRACT

An electromagnetic actuator includes: a stator; and a movable element attracted from a stroke start position to a stroke end position in a predetermined stroke in an axial direction by magnetic force generated between the stator and the movable element when a coil is energized. The stator includes a first stator located adjacent to the movable element at the stroke start position and a second stator located closer to the movable element at the stroke end position than at the stroke start position. The movable element includes a tapered portion so as to reduce a gap between the first stator and the movable element as the movable element is moved toward the stroke end position. The first stator includes a curved surface that has a convex shape so as to expand a gap between an opening end of the first stator facing the second stator and the movable element.

### CROSS REFERENCE TO RELATED APPLICATION

The present application claims the benefit of priority from Japanese Patent Application No. 2020-080243 filed on Apr. 30, 2020. The entire disclosure of the above application is incorporated herein by reference.

### TECHNICAL FIELD

The present disclosure relates to an electromagnetic actuator in which a movable element is attracted in an axial direction by magnetic force generated between a stator and the movable element.

### BACKGROUND

A known electromagnetic actuator includes two stators lined in an axial direction between a coil and a movable element.

### SUMMARY

According to the present disclosure, an electromagnetic actuator includes a stator and a movable element. The movable element is attracted from a stroke start position to a stroke end position in a predetermined stroke in an axial direction by magnetic force generated between the stator and the movable element when a coil is energized. The stator includes a first stator provided closer to the stroke start position of the movable element and a second stator provided closer to the stroke end position of the movable element. The movable element includes a tapered portion so as to reduce a gap between the first stator and the movable element as the movable element is moved toward the stroke end position. The first stator includes a curved surface so as to expand a gap between an opening end of the first stator facing the second stator and the movable element.

### BRIEF DESCRIPTION OF DRAWINGS

FIG. 1 is a sectional view of an electromagnetic actuator according to a first embodiment in the present disclosure.

FIG. 2 is a sectional view of the electromagnetic actuator after a movable element is moved to a stroke end position.

FIG. 3 is an enlarged view showing an area III in FIG. 1.

FIG. 4 is an enlarged view showing an area IV in FIG. 2.

FIG. 5 is a graph showing an attractive force characteristic of the electromagnetic actuator.

FIG. 6 is a sectional view of a part of an electromagnetic actuator in a comparative example.

FIG. 7 is a sectional view of an electromagnetic actuator according to a second embodiment in the present disclosure.

FIG. 8A is a sectional view showing a part of a first stator according to another embodiment in the present disclosure.

FIG. 8B is a sectional view showing a part of a first stator according to another embodiment in the present disclosure.

### DETAILED DESCRIPTION

An electromagnetic actuator may include two stators lined in an axial direction between a coil and a movable element. For example, in an electromagnetic actuator, a first stator is arranged closer to a stroke start position of the movable element, while a second stator is arranged closer to a stroke end position of the movable element. The movable element includes a tapered portion which has a diameter becoming smaller as close to the second stator. While the movable element is moved toward the stroke end position, an area of the gap between the movable element and the first stator is changed because of the tapered portion, and attractive force in a stroke process is equalized.

However, in the electromagnetic actuator described above, when the movable element becomes close to the second stator, the gap between the first stator and the movable element becomes smaller due to the tapered portion. Therefore, the attractive force equalized once is increased around the stroke end position, and to secure a constant attractive force characteristic over an entire length of the stroke is difficult.

The present disclosure is provided with an electromagnetic actuator configured to restrict an increase in attractive force around a stroke end position and to secure a constant attractive force characteristic over an entire length of the stroke.

According to the present disclosure, an electromagnetic actuator includes a stator and a movable element. The movable element is attracted from a stroke start position to a stroke end position in a predetermined stroke in an axial direction by magnetic force generated between the stator and the movable element when a coil is energized. The stator includes a first stator provided closer to the stroke start position of the movable element and a second stator provided closer to the stroke end position of the movable element. The movable element includes a tapered portion so as to reduce a gap between the first stator and the movable element as the movable element is moved toward the stroke end position. The first stator includes a curved surface so as to expand a gap between an opening end of the first stator facing the second stator and the movable element.

In the electromagnetic actuator in the present disclosure, when the movable element becomes close to the second stator, the gap between the first stator and the movable element becomes smaller due to the tapered portion. However, around the stroke end position, the gap between the first stator and the movable element expands due to the curved surface of the first stator. Therefore, an increase in the attractive force around the stroke end position can be restricted, and the constant attractive force characteristic can be secured over an entire length of the stroke.

### First Embodiment

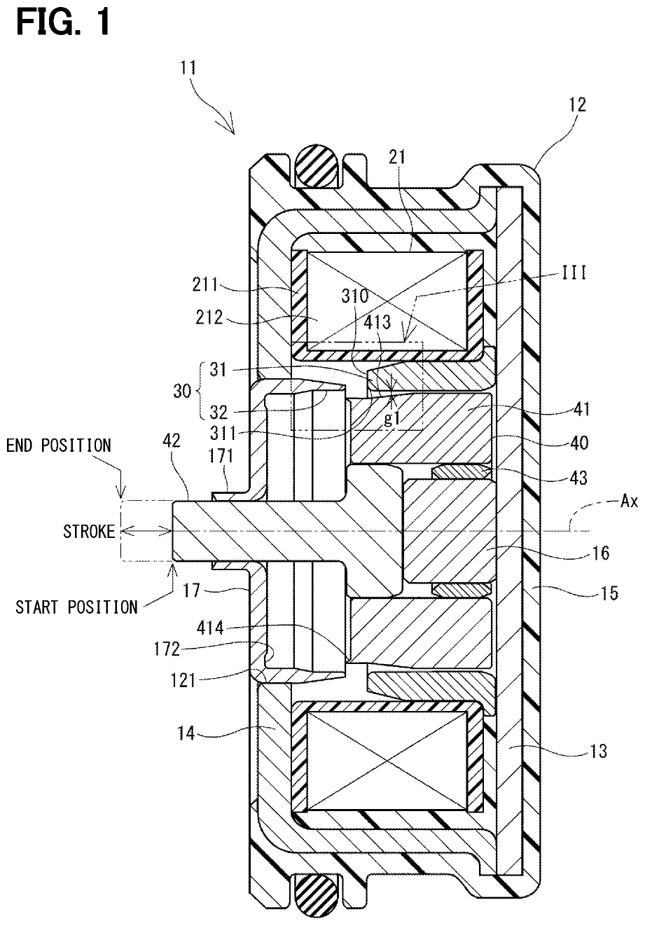

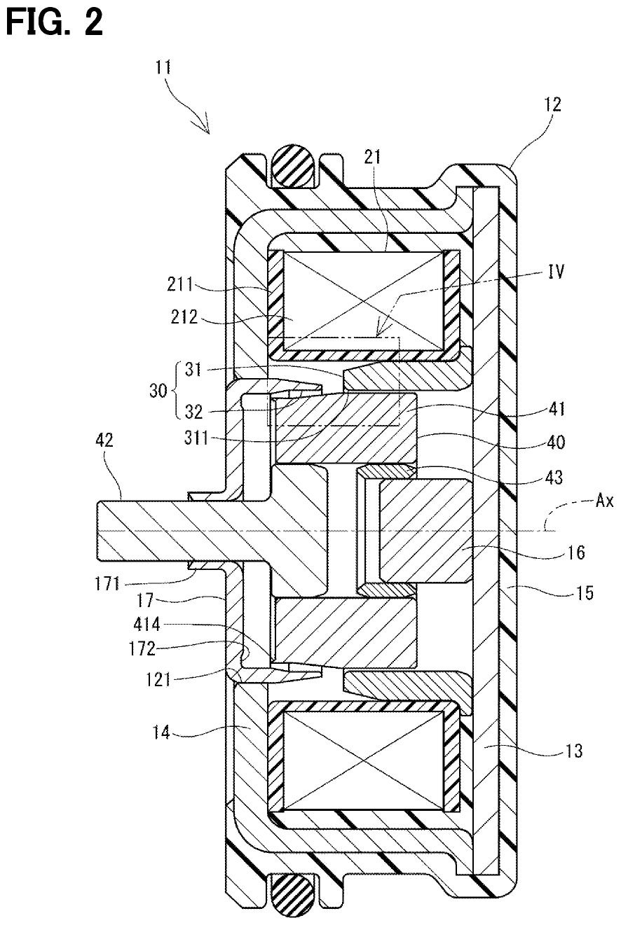

A first embodiment of the present disclosure will be described below with reference to drawings. An electromagnetic actuator 11 shown in FIGS. 1 and 2 is used as a linear solenoid for a valve timing adjustment mechanism of an internal combustion engine of a vehicle.

A housing 12 of the electromagnetic actuator 11 includes a base 13, a case 14, and an insulation film 15. The base 13 and the case 14 are made of magnetic materials. The insulation film 15 is made of resin and covers the base 13 and the case 14 entirely. A coil 21 is arranged inside the case 14 and is fixed to the housing 12 by a part of the insulation film 15. The coil 21 includes a bobbin 211 made of resin and a winding assembly 212. A whole of the coil 21 has an annular shape.

A stator 30 is arranged radially inside the coil 21, and a movable element 40 is arranged radially inside the stator 30. When the coil 21 is energized, the movable element 40 is attracted from a stroke start position to a stroke end position in a predetermined stroke in an axial direction of the electromagnetic actuator 11 by magnetic force generated between the stator 30 and the movable element 40. The axial direction described above corresponds to a direction in which an axis line Ax extends in FIG. 1.

The stator 30 includes a first stator 31 and a second stator 32. The first stator 31 is arranged closer to the stroke start position of the movable element 40. The second stator 32 is arranged closer to the stroke end position of the movable element 40. In other words, the first stator 31 and the second stator 32 are coaxially arranged such that the movable element 40 moves from a position facing the first stator 31 toward the second stator 32 when the coil 21 is energized. The first stator 31 and the second stator 32 are arranged radially inside the coil 21 so as to miniaturize the electromagnetic actuator 11. The first stator 31 is made of magnetic material and is formed in a cylindrical shape by a cold forging process. A base end portion of the first stator 31 is fixed to the base 13. The second stator 32 is formed in a cylindrical part of a cover member 17 made of magnetic material. The cover member 17 is fixed to the case 14 so as to cover a front opening 121 of the housing 12.

In the movable element 40, a cylinder 41, a plunger 42, and a slider 43 are combined so as to be movable integrally. The cylinder 41 is made of magnetic material and is formed by a sintering process. The plunger 42 is an output shaft of the electromagnetic actuator 11. The cylinder 41 is provided inside the first stator 31 and the second stator 32 through a gap. A base of the plunger 42 is fixed to an inner wall surface of the cylinder 41 at an end portion. In this situation, the plunger 42 is positioned on the axis line Ax of the electromagnetic actuator 11.

The slider 43 is made of low friction material and has a circular shape. The slider 43 is fixed to the inner wall surface of the cylinder 41 at a base end portion. A guide member 16 configured as a stopper of the plunger 42 is fixed to the base 13. The slider 43 is slidably fitted to the guide member 16. In addition, a boss portion 171 is formed on a center of the cover member 17. The plunger 42 is inserted into the boss portion 171 slidably. That is, movement of the movable element 40 is guided by the guide member 16 and the cover member 17.

The first stator 31 and the second stator 32 are lined along a direction in which the movable element 40 is attracted and are arranged radially inside the coil 21. When the coil 21 is energized, the movable element 40 is attracted from the stroke start position to the stroke end position by magnetic force generated between the movable element 40 and the first stator 31 and by magnetic force generated between the movable element 40 and the second stator 32. FIG. 1 shows the movable element 40 at the stroke start position, and FIG. 2 shows the movable element 40 at the stroke end position.

The stroke end position is not limited to a position shown in FIG. 2. The stroke end position may be set forward of a position shown in FIG. 2, that is may be set closer to the cover member 17, depending on an usage of the electromagnetic actuator 11. When energization to the coil 21 is stopped, the movable element 40 returns from the stroke end position to the stroke start position because of a spring arranged in a driven device such as the valve timing adjustment mechanism.

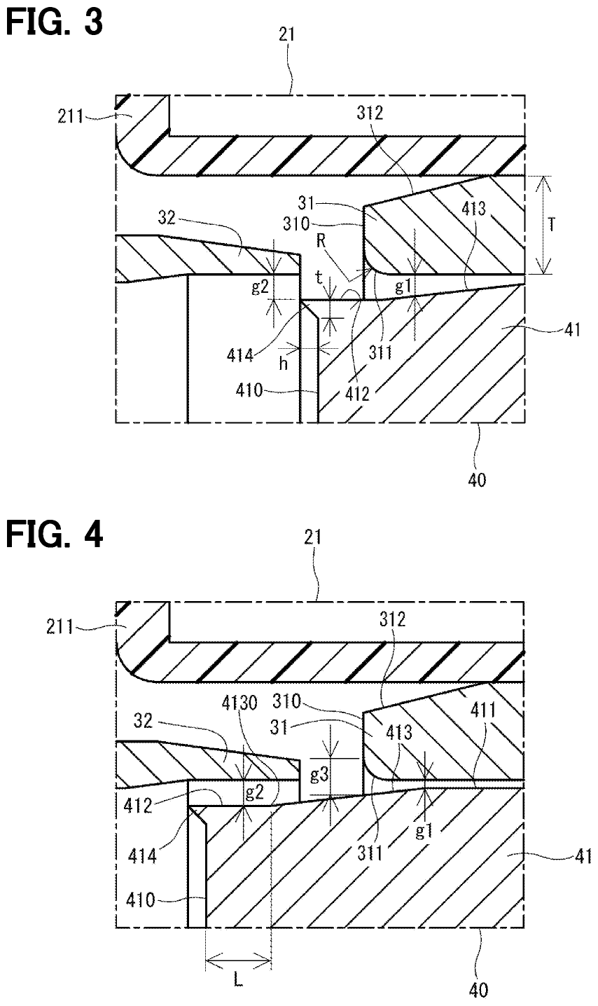

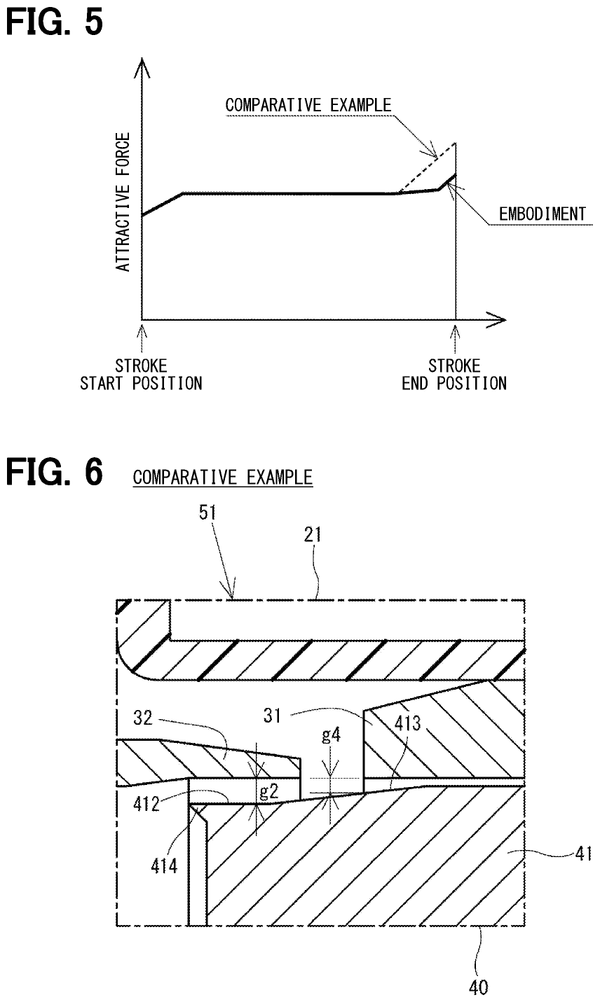

As shown in FIGS. 3 and 4, the cylinder 41 of the movable element 40 includes a large diameter cylindrical portion 411 referred to FIG. 4, a small diameter cylindrical portion 412, and the tapered portion 413. The large diameter cylindrical portion 411 is provided at one end of the cylinder 41 toward the stroke start position with respect to the tapered portion 413. The small diameter cylindrical portion 412 is provided at the other end of the cylinder 41 toward the stroke end position with respect to the tapered portion 413. The tapered portion 413 is provided between the large diameter cylindrical portion 411 and the small diameter cylindrical portion 412. The tapered portion 413 is formed such that a diameter of an outer peripheral surface becomes larger toward the stroke start position of the movable element 40 and becomes smaller toward the stroke end portion of the movable element 40. Accordingly, as the movable element 40 is moved toward the stroke end position, an area of a gap (g1) between the first stator 31 and the movable element 40 in the radial direction is changed because of the tapered portion 413. Therefore, attractive force in a stroke process is equalized, as referred to FIG. 5.

The small diameter cylindrical portion 412 has a constant diameter in the axial direction, and an outer wall surface of the small diameter cylindrical portion 412 has a straight line as shown in FIG. 3. The small diameter cylindrical portion 412 is formed continually from the tapered portion 413 toward the second stator 32. The outer peripheral surface of the small diameter cylindrical portion 412 is a cylindrical surface. The outer diameter of the small diameter cylindrical portion 412 is approximately same as that of a minimum diameter edge 4130 of the tapered portion 413, as shown in FIG. 4. Because of the small diameter cylindrical portion 412, an area of a gap (g2) between the movable element 40 and the second stator 32 in the radial direction is approximately constant in an area from the stroke start position to the stroke end position in the axial direction. A length (L) of the small diameter cylindrical portion 412 in the axial direction is preferably a stroke length of the movable element 40 or less. If the length of the small diameter cylindrical portion 412 is over the stroke length, control of the attractive force by the tapered portion 413 may be adversely affected.

In the movable element 40, a protrusion 414 is provided on a front end of the cylinder 41 in the axial direction. A cross section of the protrusion 414 has a triangular shape. The protrusion 414 protrudes from an end surface 410 of the cylinder 41 toward the stroke end position and is formed circularly over a whole circumference of the small diameter cylindrical portion 412. As shown in FIG. 3, a thickness (t) of the protrusion 414 in a radial direction of the cylinder 41 is preferably around 0.05 mm to 1 mm. In addition, a protrusion height (h) of the protrusion 414 in the axial direction is preferably a half of the stroke length of the movable element 40 or less.

As shown in FIGS. 1 and 2, a recess portion 172 is formed on an inner side of the cover member 17 at a recessed part and is opposed to the protrusion 414. The recess portion 172 is formed in an annular shape and has a depth so as to enable the protrusion 414 to enter. Therefore, when the stroke end position of the movable element 40 is positioned closer to the cover member 17 than the position shown in FIG. 2, collision of the cover member 17 with the protrusion 414 can be restricted.

In the first stator 31, the curved surface 311 which has a convex shape is formed circularly on an opening end 310 facing the second stator 32. As shown in FIGS. 3 and 4, the curved surface 311 is provided on an area from the opening end 310 of the first stator 31 formed in a tubular shape to an inner peripheral surface of the first stator 31. Therefore, when the movable element 40 becomes closer to the stroke end position, a gap (g3) between the first stator 31 and the movable element 40 in the radial direction is expanded because of the curved surface 311. In addition, a slope 312 is formed on an outer peripheral surface of the first stator 31 at a side opposite to the curved surface 311. Because of the slope 312, a thickness (T) of the first stator 31 in the radial direction, as shown in FIG. 3, is reduced toward the second stator 32.

In FIG. 3, a radius (R) of the curved surface 311 is preferably in a range from 0.2 mm to 90% of the thickness (T) of the first stator 31. More preferably, the radius (R) of the curved surface 311 is around 0.3 mm to 3 mm.

In the electromagnetic actuator 11 structured as described above, as shown in FIG. 3, when the movable element 40 is positioned at the stroke start position, the minimum diameter edge 4130 of the tapered portion 413 is close to the second stator 32. However, the small diameter cylindrical portion 412 is formed continually from the tapered portion 413 toward the second stator 32. In addition, the protrusion 414 protrudes from the end surface 410 of the cylinder 41 toward the cover member 17. Therefore, the gap (g2) between the movable element 40 and the second stator 32 in the radial direction is not enlarged when the movable element 40 is positioned around the stroke start position. That is, the gap (g2) between the cylinder 41 and the second stator 32 is kept relatively small, and the attractive force at an initial stage of a starting of the electromagnetic actuator 11 can be restricted from being decreased.

As shown in FIG. 4, as the movable element 40 becomes closer to the stroke end position, the gap (g1) between the movable element 40 and the first stator 31 in the radial direction becomes smaller because of the tapered portion 413. However, immediately before the movable element 40 reaches the stroke end position, the gap (g3) between the movable element 40 and the first stator 31 is expanded because of the curved surface 311. Because of this, the attractive force applied to the movable element 40 is reduced. Therefore, as shown in FIG. 5, an increase in the attractive force around the stroke end position can be restricted, and a constant attractive force characteristic can be secured over the entire length of the stroke.

FIG. 6 shows an electromagnetic actuator 51 in a comparative example. In the electromagnetic actuator 51 in the comparative example, the cylinder 41 of the movable element 40 includes the small diameter cylindrical portion 412, the tapered portion 413, and the protrusion 414. However, a curved surface is not provided on the first stator 31. Therefore, the attractive force is equalized by the tapered portion 413 in the stroke process. However, a radial gap (g4) becomes smaller around the stroke end position because of the tapered portion 413, and the attractive force is increased as shown by a broken line in FIG. 5. Accordingly, the constant attractive force characteristic cannot be secured over the entire length of the stroke.

### Second Embodiment

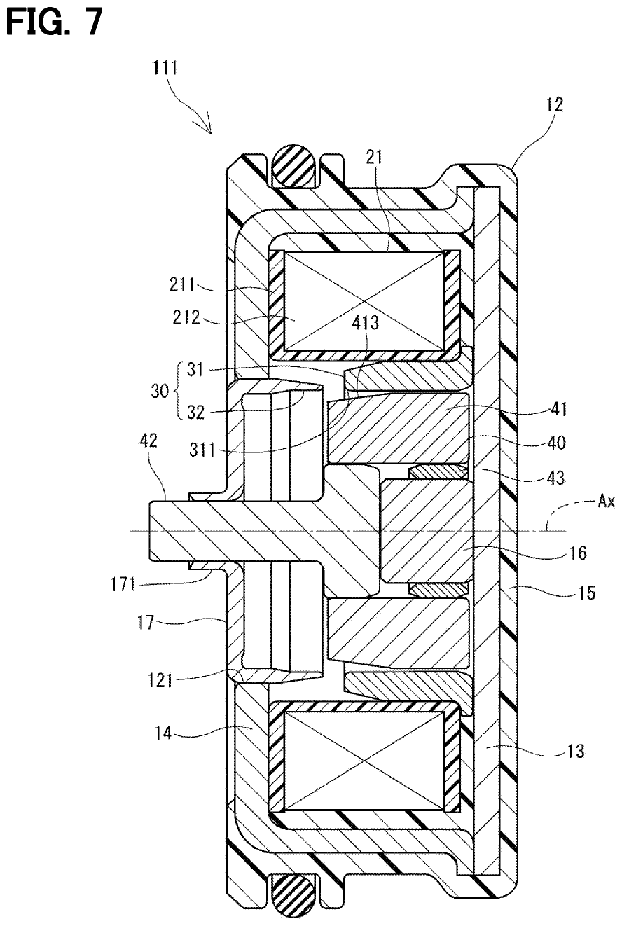

A second embodiment of the present disclosure will be described below with reference to FIG. 7. An electromagnetic actuator 111 in the second embodiment is different from the electromagnetic actuator 11 in the first embodiment such that the movable element 40 does not include the small diameter cylindrical portion or the protrusion. However, similarly to the first embodiment, in the electromagnetic actuator 111 in the second embodiment, the movable element 40 includes the tapered portion 413, and the first stator 31 includes the curved surface 311. Therefore, the increase in the attractive force around the stroke end position can be restricted by expanding a gap between the first stator 31 and the movable element 40, and the constant attractive force characteristic can be secured over the entire length of the stroke.

### Other Embodiments

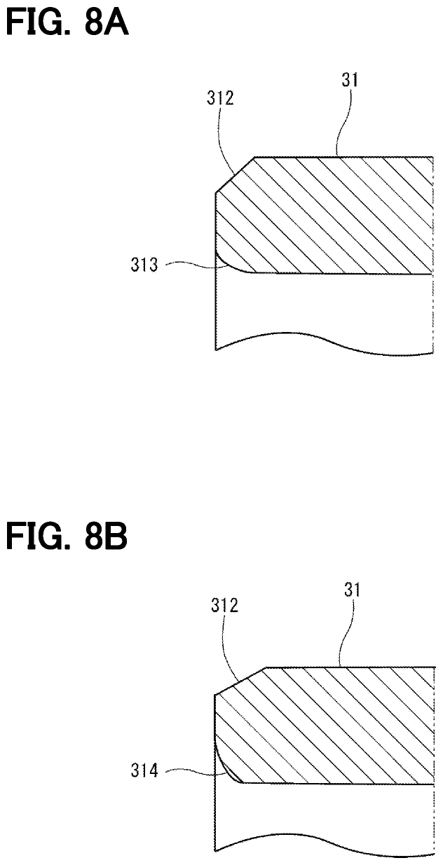

(1) In the above embodiments, the curved surface 311 is provided on the first stator 31 and forms a quarter of a cylinder which has the radius (R). However, in other embodiments, a shape of the curved surface may be appropriately changed. A curved surface 313 shown in FIG. 8A is provided on the first stator 31 and corresponds to a quarter of an ellipsoid which has a major axis extending in the axial direction of the first stator 31. A curved surface 314 shown in FIG. 8B is provided on the first stator 31 and corresponds to a quarter of an ellipsoid which has a major axis extending in the radial direction of the first stator 31.

(2) In the above embodiments, the stator 30 is arranged radially inside the coil 21, and the movable element 40 is arranged radially inside the stator 30. However, in other embodiments, the stator may be arranged radially outside the coil, the movable element may be arranged radially outside the stator, and a curved surface may be formed on the outer peripheral surface of the first stator.

(3) In the above embodiment, the electromagnetic actuator 11 used for the valve timing adjustment mechanism is shown. However, use of the electromagnetic actuator is not limited. In other embodiments, the electromagnetic actuator of the present disclosure may be applied to various equipment or device rather than the valve timing adjustment mechanism.

(4) The present disclosure is not limited to the above embodiments and can be appropriately modified in structure or configuration of each part without departing from a spirit of the present disclosure.

What is claimed is:

1. An electromagnetic actuator comprising:
a stator; and
a movable element attracted from a stroke start position to a stroke end position in a predetermined stroke in an axial direction by magnetic force generated between the stator and the movable element when a coil is energized, wherein
the stator includes a first stator located adjacent to the movable element at the stroke start position and a second stator located closer to the movable element at the stroke end position than at the stroke start position,
the movable element includes a tapered portion so as to reduce a gap between the first stator and the movable element as the movable element is moved toward the stroke end position, and
the first stator includes a curved surface that has a convex shape so as to expand a gap between an opening end of the first stator facing the second stator and the movable element.

2. The electromagnetic actuator according to claim 1, wherein
the curved surface is formed circularly on the opening end of the first stator that has a cylindrical form.

3. The electromagnetic actuator according to claim 1, wherein
the first stator and the second stator are arranged radially inside the coil.

4. The electromagnetic actuator according to claim 1, wherein
a radius of the curved surface is in a range from 0.2 mm to 90% of a thickness of the first stator in a radial direction.
